(19) United States
(12) Patent Application Publication
(10) Pub. No.: US 2022/0403971 A1
(43) Pub. Date: Dec. 22, 2022

(54) NOTCHED MAGNETIC MOUNT HEAD

(71) Applicant: PopSockets LLC, Boulder, CO (US)

(72) Inventors: Nicholas Von Bargen, Boulder, CO (US); Karla Sofia Zapata-Garcia, Boulder, CO (US); Randy Yang Chiang, Boulder, CO (US); Lawrence Herman Fong, Boulder, CO (US); Michael J. Kory, Boulder, CO (US)

(21) Appl. No.: 17/353,352

(22) Filed: Jun. 21, 2021

(51) Int. Cl. F16M 11/04; F16M 11/22; A45F 5/00

(52) U.S. Cl. CPC F16M 11/041; F16M 11/22; A45F 5/00; A45F 2200/0516; H04B 1/3888

(57) ABSTRACT

A mount for a portable electronic device includes a mount base to attach the mount to a surface, and a mount head attached to the mount base. The mount head includes an attachment surface having one or more magnetic elements configured to magnetically attach the mount head to the portable electronic device. The mount head also comprises a central receiving region, along with two recess portions laterally disposed from the central receiving region, which together accommodate an accessory attachment and associated lateral engaging regions.

### FIELD OF THE DISCLOSURE

The present disclosure generally relates to a magnetic mount head, and more particularly, to a magnetic mount head which interfaces with one or more magnetic elements integrated into a portable electronic device and case, and with a notched configuration allowing for a slidable sub-assembly to be simultaneously attached to the portable electronic device and case.

### BACKGROUND

Portable electronic devices, such as MP3 players and smart phones, are often housed in protective covers or cases in order to protect the device from damage, provide a grip for handling the device, and/or provide a stand for propping the device on a surface. Such cases increase the effective size of the device. Expandable accessories, which may be attached directly to the device or to the case protecting the device, are used for a variety of functions, including propping the device on a surface and providing an expandable grip for handling the device.

### SUMMARY OF THE INVENTION

One aspect of the disclosure relates to a mount for a portable electronic device. In certain embodiments, the mount has a mount base configured to attach the mount to a surface, and a mount head attached to the mount base. The mount head may comprise an attachment surface having one or more magnetic elements configured to magnetically attach the mount head to the portable electronic device. The mount head may further comprise a central receiving region and two recess portions laterally disposed from the central receiving region.

Another aspect of the disclosure relates to a mount system for a portable electronic device. The mount system may include a mount head comprising an attachment surface having one or more magnetic elements configured to magnetically attach the mount head to the portable electronic device. The mount system may also include an accessory attachment having lateral engaging regions configured to attach to accessory attachment to the portable electronic device by engaging respective side surfaces of the portable electronic device. The mount head may have a central receiving region and two recess portions laterally disposed from the central receiving region. The central receiving region may be configured to receive the accessory attachment, while the two recess portions may be configured to receive the lateral engaging regions, such that the portable electronic device is flush with the attachment surface of the mount head when magnetically attached thereto.

### BRIEF DESCRIPTION OF THE DRAWINGS

The features of this disclosure which are believed to be novel are set forth with particularity in the appended claims. The present disclosure may be best understood by reference to the following description taken in conjunction with the accompanying drawings, in which like reference numerals identify like elements in the several figures, in which:

FIG. 1 is a perspective view of a portable electronic device configured with an attached slidable accessory attachment device, in accordance with the principles of the disclosure;

FIGS. 2A-2E depict various views of mount head configured to be attachable to a portable electronic device in accordance with the principles of the disclosure;

FIG. 3 depicts a side view of a mount head configured in accordance with the principles of the disclosure;

FIGS. 4A-4C depict top views of one example of a mount head configured to be rotatable in accordance with the principles of the disclosure;

FIGS. 5A-5B depict top views of another example of a mount head configured to be rotatable in accordance with the principles of the disclosure;

FIG. 6A depicts a cross sectional view of a portable electronic device with an attached slidable accessory attachment device and mounted to a mount head configured in accordance with the principles of the disclosure; and

FIG. 6B depicts a side view of the arrangement of FIG. 6A.

### DESCRIPTION OF THE EXEMPLARY EMBODIMENTS

The present disclosure is generally directed to a magnetic mount head that is configured to removably and interchangeably receive a plurality of different expandable accessories attached to a portable electronic device (either the same portable electronic device or different portable electronic devices), such that the magnetic mount head is configured to retain the portable electronic device without having to remove the accessory attached thereto and regardless of which kind of accessory is attached thereto. In particular, the disclosed mount includes an attachment mechanism, a receiving member, and a connection member that is coupled to the disc and the receiving member. The mount described herein may be configured in accordance with the disclosure set forth in U.S. application Ser. No. 16/814,265, filed on Mar. 10, 2020, the entirety of which is hereby incorporated by reference.

The present disclosure is further directed to a magnetic mount head, as described above, which is further configured with a recess or notch within which a slidable platform, which is attached to the portable electronic device (or a case thereof) can be accommodated even when the magnetic mount head is magnetically engaged to the portable electronic device. Moreover, the magnetic mount head may be rotatably engaged with a mount, such that the portable electronic device, when engaged to a mount head configured in accordance with the description herein, may be oriented in portrait or landscape positions.

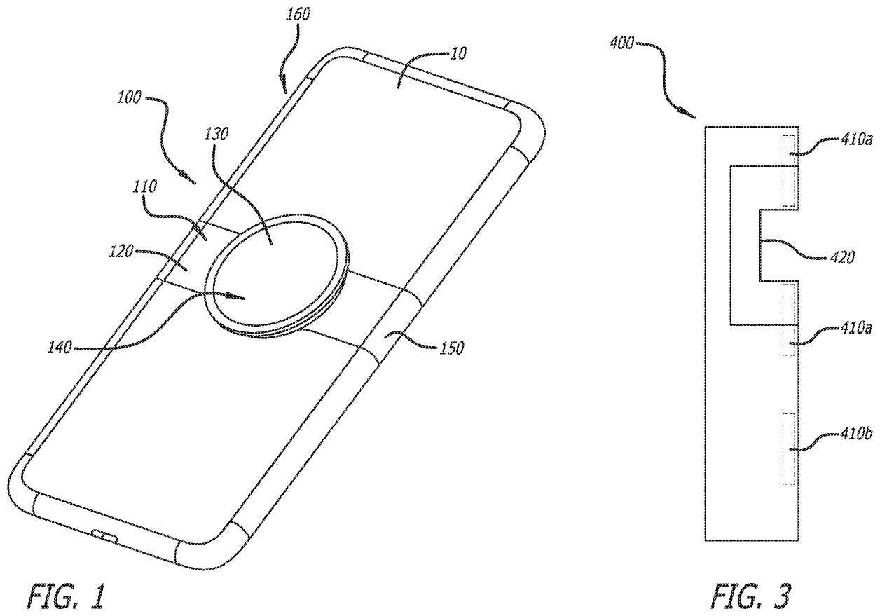

Referring first to FIG. 1, illustrated is one embodiment of a slidable accessory attachment device 100 in the form of a slidable grip device for use with a portable electronic device 10. The slidable accessory attachment device 100 includes a platform 110 having a top side 120, a collapsible and/or expandable mechanism or body (not shown) operably coupled to the platform 110, and a button 130 having a top or upper side 140. In some examples, the expandable grip device 100 further includes a storage receptacle defined by the body and/or the button 130.

The platform 120 additionally includes at least one engaging region or arm 150 that, generally speaking, engages and/or secures with an outer edge 160 of the portable electronic device 10 (or an outer edge of a case for the portable electronic device). The slidable accessory attachment device 100 may be moveable between an expanded configuration (not illustrated) and a collapsed configuration (FIG. 1). The button 130 may be removable from the slidable accessory attachment device 100. Moreover, the body and button 130 may be removable from the platform 110.

In the illustrated example, the platform 110 of the slidable accessory attachment device 100 includes two engaging regions (or arms) 150, each of which is positioned at an end of the platform 110. The engaging regions 150 are in the form of curved members that are dimensioned to conform to and/or wrap around the outer edge 160 of the portable electronic device 10 (or an outer edge of a case for the portable electronic device if so equipped). In other examples, the engaging regions (or arms) 150 may have a non-curved configuration but may still conform to and/or wrap around the outer edge 160 of the portable electronic device 10.

The platform 110 and the engaging regions (or arms) 150 may be dimensioned such that they frictionally engage the outer edge 160 of the portable electronic device 10 to retain the slidable accessory attachment device 100 thereto. In some examples, the slidable accessory attachment device 100 may be dimensioned to be slidable along the height of the portable electronic device 10 while still being frictionally engaged therewith. In some examples, the engaging regions (or arms) 150 may include a gripping material such as a tacky material, a temporary adhesive, and the like, that increases friction with the outer edge 160 of the portable electronic device 10. In general, the slidable accessory attachment device 100 may be configured in accordance with the disclosure set forth in U.S. application Ser. No. 17/021,535, filed on Sep. 15, 2020, the entirety of which is hereby incorporated by reference.

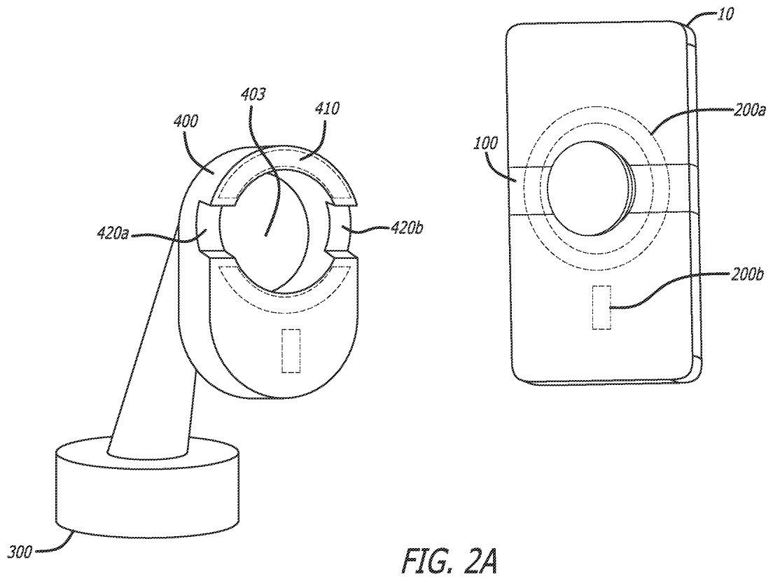

Referring now to FIG. 2A, depicted is a portable electronic device 10 configured with one or more integrated magnetic element(s) 200, which is shown as comprised of both a ring shaped magnetic portion (200a) and a separate alignment element (200b), but may have other configurations as well. Here, the portable electronic device 10 is configured with accessory attachment device 100, as described above. A notched magnetic mount head 400 is attached to a mount base 300. It should be appreciated that mount base 300 may comprise any structure which provides or promotes the attachment of the mount head 400 to a surface, such as a countertop, vent, dashboard, windshield, desk, laptop, appliance, etc. In other embodiments, a rear face of the mount head 400 (not shown) may be configured to adhesively or magnetically attach directly to a surface.

Mount head 400 is configured with one or more magnetic element(s) 410, thereby forming a magnetic mount head, and is configured to removably and interchangeably receive a plurality of different accessories within its central opening that may be attached to the portable electronic device 10, including the slidable accessory attachment device 100 described above. As shown in FIG. 2A, mount head magnetic element(s) 410 may have a complementary configuration to the magnets 200 of device 10. As such, when the portable electronic device 10 is brought within magnetic proximity of the magnetic mount head 400, magnets 200 and magnetic element(s) 410 attract, thereby causing the portable electronic device 10 to be magnetically attached to the mount head 400. It should be appreciated that throughout this disclosure, references to ‘magnetic elements’ includes references to magnets, as well as to magnet-attracting materials.

The mount head 400 is further configured with a central receiving region 403 into which the slidable accessory attachment device 100 may be received when the portable electronic device 10 is mounted to the mount head 400. In particular, the central receiving region would receive and accommodate the platform 110, body and/or button 130 of the slidable accessory attachment device 100 and, in general, any other centrally disposed structure of the slidable accessory attachment device 100.

It should be appreciated that the mount head 400 may have a pill-shaped design as shown in FIGS. 2A-2C, which may provide additional support, especially against cleavage forces. Alternatively, the mount head 400 may also have a circular design or another shape.

Continuing to refer to FIG. 2A, mount head 400 is also configured with a notch/recess 420a and 420b disposed at opposing sides of the mount head's structure, as shown in FIG. 2A. In certain embodiments, notch/recess 420a and 420b are configured to align with and accommodate the slidable accessory attachment device 100 of FIG. 1. In particular, when the mount head 400 is magnetically attached to device 10, the notch/recess 420a and 420b may be configured to accommodate the two engaging regions (or arms) 150 of the platform 110 of the slidable accessory attachment device 100 of FIG. 1, while the central open region of the mount head 400 would accommodate the button/body of the slidable accessory attachment device 100.

FIG. 2B depicts another example of a portable electronic device 10 configured with one or more integrated magnets (not shown) and equipped with an accessory attachment device 100, as described above. A notched magnetic mount head 400, detached from the mount base of FIG. 2A, is shown in alignment with the accessory attachment device 100 for attachment thereto, as described below.

FIGS. 2C-2E depict the notched magnetic mount head 400 configured to attach to a clip-style base 310. In certain embodiment, the clip-style base 310 may be configured to attach to a vehicle air conditioning vent or the like. The notched magnetic mount head 400 is configured to engage with, and be rotatable relative to, the clip-style base 310. In particular, the clip-style base 310 may include an engaging ring 320 into which an extending portion 405 of the mount head 400 may be press fit so to provide a freely rotatable engagement between the clip-style base 310 and mount head 400. It should be appreciated that the engaging ring 320 may be a contiguous ring or may be comprised of a number of discrete sections extending generally in a circular orientation, as is shown in the example of FIG. 2C. Moreover, a lip 330 may be disposed at the distal end of the engaging ring 320, as is shown in FIGS. 2C-2E, so as to further secure the mount head 400 to the base 300, while not restricting the rotatable engagement therebetween. It should of course be appreciated that the engagement mechanism between the clip-style base 310 and mount head 400 may vary in design, and that the clip-style base 310 may be configured with other attachment structures, such as a magnetic- or adhesive-based attachment structure.

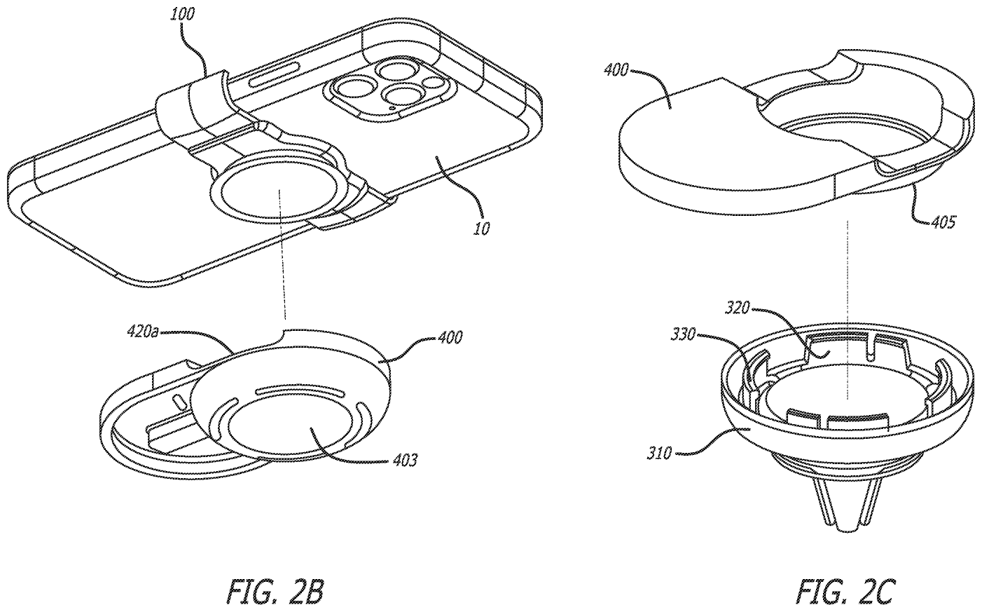

FIG. 3 depicts a cross-sectional side view of the mount head 400 with magnetic element(s) comprising a magnetic ring portion 410a and a separate alignment portion 410b.

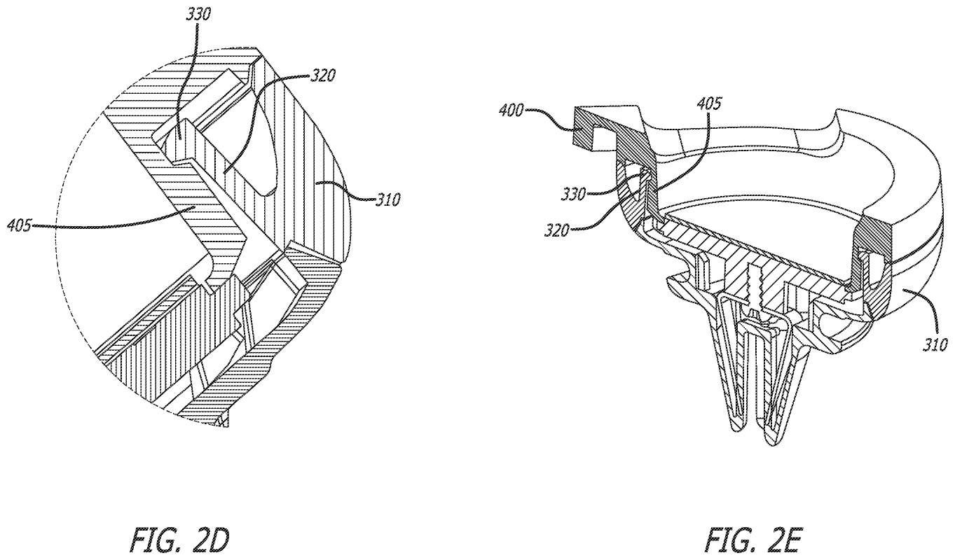

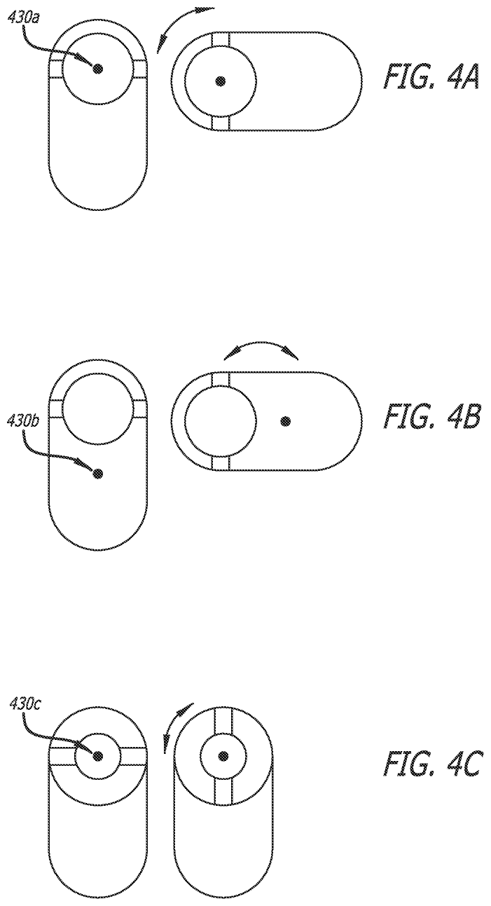

As noted above, the mount head 400 may be configured to rotate relative to the mount base 300. To that end, FIGS. 4A-4C depicted are various embodiments in which the mount head of the present disclosure is rotatable. In FIG. 4A, the axis of rotation 430a is aligned with the mount head opening, while in FIG. 4B the axis of rotation 430b is aligned centrally with the overall mount head structure. Rotation may be achieved using the arrangement described above with respect to FIG. 2C. Finally, in FIG. 4C the mount head is configured with a first portion that is rotatable relative to a second portion of the mount head itself, as described in more detail below with respect to FIG. 5A.

Referring now to FIGS. 5A-5B, depicted are two options for providing a rotatable mount head in accordance with the principles of the disclosure. In FIG. 5A, mount head 400 is comprised of a circle portion 440a and a pill portion 450a. In this embodiment, the pill portion 450a remains affixed to the mount base (not shown), while the circle portion 440a is permitted to rotate relative to the pill portion 450a. as shown. Such engagement may be achieved using the approach described above with respect to FIG. 2C.

In FIG. 5B, the mount head 400 is once again comprised of a circle portion 440a and a pill portion 450a. However, in this case both the circle portion 440a and the pill portion 450a are permitted to rotate, and therefore the overall mount head 400 rotates relative to the mount base (not shown). The interior dashed line demarcates the portion of the mount head 400 for FIGS. 5A-5B corresponding to an attachment surface by which a rear surface of the mount head 400 is securable to a mounting base.

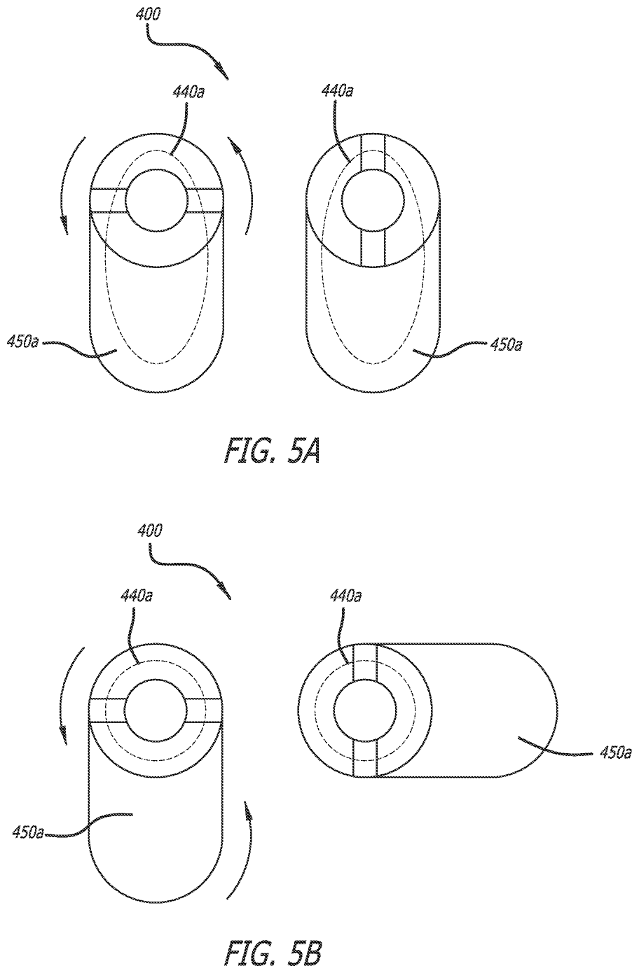

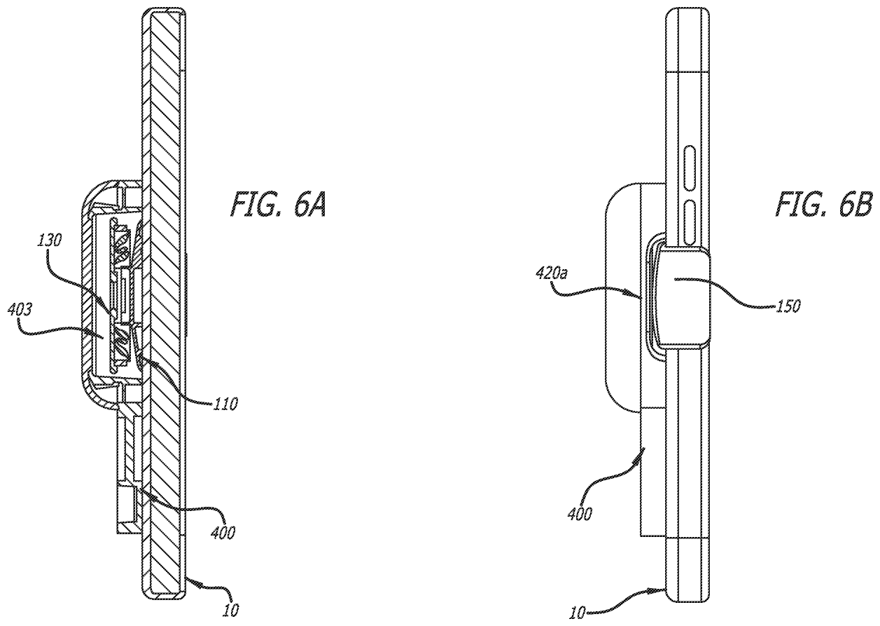

FIGS. 6A-6B depict side views of a mount head 400, configured in accordance with the principles of the disclosure, with the slidable accessory attachment device 100 described above, wherein the slidable accessory attachment device 100 is further engaged with a portable electronic device 10 as also described above.

As described above, and as further shown in FIGS. 6A-6B, the slidable accessory attachment device 100 includes engaging region(s) 150 to secure the slidable accessory attachment device 100 to a portable electronic device 10 is a slidable configuration. As also described above, a central receiving region 403 (see FIG. 6A) of the mount head 400 is configured to accommodate the slidable accessory attachment device 100 when the portable electronic device 10 is mounted to the mount head 400, while the notches/recesses 420a and 420b (see notch/recess 420a of FIG. 6B) are further configured to accommodate the engaging region(s) 150 of the slidable accessory attachment device 100. In this manner, a portable electronic device 10 can be flush mounted to the mounting head disclosed herein even when configured with a slidable accessory attachment device.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of various embodiments. This description should be read to include one or at least one and the singular also includes the plural unless it is obvious that it is meant otherwise.

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A mount for a portable electronic device, the mount comprising:
a mount base configured to attach the mount to a surface; and
a mount head attached to the mount base, wherein the mount head comprises an attachment surface having one or more magnetic elements configured to magnetically attach the mount head to the portable electronic device,
wherein the mount head further comprises a central receiving region and two recess portions laterally disposed from the central receiving region.

2. The mount of claim 1, wherein, when an accessory attachment having lateral engaging regions is attached to the portable electronic device, the central receiving region is configured to receive the accessory attachment and the two recess portions are configured to receive the lateral engaging regions, such that the portable electronic device is flush with the attachment surface of the mount head when magnetically attached thereto.

3. The mount of claim 2, wherein the two lateral engaging regions comprise two lateral arms that extend from the accessory attachment to engage respective side surfaces of the portable electronic device

4. The mount of claim 3, wherein the accessory attachment and lateral arms are slidable along the side surfaces of the portable electronic device so as to be positionable along a length of the portable electronic device.

5. The mount of claim 2, wherein the accessory attachment comprises a collapsible and expandable grip accessory.

6. The mount of claim 2, wherein the two recess portions comprise notches formed in the attachment surface on opposing sides of the central receiving region.

7. The mount of claim 1, wherein the one or more magnets are disposed at the attachment surface, circumferentially around at least a portion of the central receiving region.

8. The mount of claim 7, wherein the one or more magnets are disposed entirely around the central receiving region.

9. The mount of claim 7, wherein the mount head comprises a pill shaped configuration in which the central receiving region is formed in a first side of the pill shaped configuration, and wherein the one or more magnetic elements further comprise an alignment magnetic element positioned on the attachment surface at a second side of the pill shaped configuration.

10. The mount of claim 1, wherein the mount head comprises a pill shape in which the central receiving region is formed in a first side of the pill shaped configuration, and wherein the mount base attaches to the mount head at a second side of the pill shaped configuration.

11. The mount of claim 1, wherein the mount head is rotatable relative to the mount base.

12. The mount of claim 1, wherein the mount head and mount base are integrally formed.

13. The mount of claim 1, wherein the one or more magnetic elements disposed in the attachment surface of the mount head are configured to magnetically attach to one or more magnets disposed in the portable electronic device.

14. The mount of claim 13, wherein the one or more magnetic elements comprise one or more magnets.

15. A mount system for a portable electronic device, the mount system comprising:
a mount head comprising an attachment surface having one or more magnetic elements configured to magnetically attach the mount head to the portable electronic device; and
an accessory attachment having lateral engaging regions configured to attach to accessory attachment to the portable electronic device by engaging respective side surfaces of the portable electronic device,
wherein the mount head comprises a central receiving region and two recess portions laterally disposed from the central receiving region,
wherein the central receiving region is configured to receive the accessory attachment and the two recess portions are configured to receive the lateral engaging regions, such that the portable electronic device is flush with the attachment surface of the mount head when magnetically attached thereto.

16. The mount system of claim 15, wherein the two lateral engaging regions comprise two lateral arms that extend from the accessory attachment to engage respective side surfaces of the portable electronic device

17. The mount system of claim 16, wherein the accessory attachment and lateral arms are slidable along the side surfaces of the portable electronic device so as to be positionable along a length of the portable electronic device.

18. The mount system of claim 15, wherein the accessory attachment comprises a collapsible and expandable grip accessory.

19. The mount system of claim 15, wherein the two recess portions comprise notches formed in the attachment surface on opposing sides of the central receiving region.

20. The mount system of claim 15, wherein the one or more magnets are disposed at the attachment surface, circumferentially around at least a portion of the central receiving region.

21. The mount system of claim 20, wherein the one or more magnets are disposed entirely around the central receiving region.

22. The mount system of claim 20, wherein the mount head comprises a pill shaped configuration in which the central receiving region is formed in a first side of the pill shaped configuration, and wherein the one or more magnetic elements further comprise an alignment magnetic element positioned on the attachment surface at a second side of the pill shaped configuration.

23. The mount system of claim 15, wherein the mount system further comprises a mount base attached to the mount head, wherein the mount base is configured to attach the mount head to a surface.

24. The mount system of claim 23, wherein the mount head comprises a pill shape in which the central receiving region is formed in a first side of the pill shaped configuration, and wherein the mount base attaches to the mount head at a second side of the pill shaped configuration.

25. The mount system of claim 23, wherein the mount head is rotatable relative to the mount base.

26. The mount system of claim 15, wherein the one or more magnetic elements disposed in the attachment surface of the mount head are configured to magnetically attach to one or more magnets disposed in the portable electronic device.

27. The mount system of claim 15, wherein the one or more magnetic elements comprise one or more magnets.
